(19) United States
(12) Patent Application Publication
(10) Pub. No.: US 2009/0091529 A1
(43) Pub. Date: Apr. 9, 2009

(54) Rendering Display Content On A Floor Surface Of A Surface Computer

(75) Inventors: Lydia M. Do, Raleigh, NC (US); Pamela A. Nesbitt, Tampa, FL (US); Lisa A. Seacat, San Francisco, CA (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 11/869,313

(22) Filed: Oct. 9, 2007

(51) Int. Cl. G09G 5/00

(52) U.S. Cl. 345/156

(57) ABSTRACT

Methods, apparatus, and products are disclosed for rendering display content on a floor surface of a surface computer, the floor surface comprised in the surface computer, the surface computer capable of receiving multi-touch input through the floor surface and rendering display output on the floor surface, that include: detecting, by the surface computer, contact between a user and the floor surface; identifying, by the surface computer, user characteristics for the user in dependence upon the detected contact; selecting, by the surface computer, display content in dependence upon the user characteristics; and rendering, by the surface computer, the selected display content on the floor surface.

### BACKGROUND OF THE INVENTION

1. Field of the Invention

The field of the invention is data processing, or, more specifically, methods, apparatus, and products for rendering display content on a floor surface of a surface computer.

2. Description of Related Art

Multi-touch surface computing is an area of computing that has made tremendous advancements over the last few years. Multi-touch surface computing allows a user to interact with a computer through a surface that is typically implemented as a table top. The computer renders a graphical user interface (‘GUI’) on the surface and users may manipulate GUI objects directly with their hands using multi-touch technology as opposed to using traditional input devices such as a mouse or a keyboard. In such a manner, the devices through which users provide input and receive output are merged into a single surface, which provide an intuitive and efficient mechanism for users to interact with the computer. As surface computing becomes more ubiquitous in everyday environments, readers will appreciate advancements in how users may utilize surface computing to intuitively and efficiently perform tasks that may be cumbersome using traditional input devices such as a keyboard and mouse.

### SUMMARY OF THE INVENTION

Methods, apparatus, and products are disclosed for rendering display content on a floor surface of a surface computer, the floor surface comprised in the surface computer, the surface computer capable of receiving multi-touch input through the floor surface and rendering display output on the floor surface, that include: detecting, by the surface computer, contact between a user and the floor surface; identifying, by the surface computer, user characteristics for the user in dependence upon the detected contact; selecting, by the surface computer, display content in dependence upon the user characteristics; and rendering, by the surface computer, the selected display content on the floor surface.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary surface computer capable of rendering display content on a floor surface according to embodiments of the present invention.

FIG. 2A sets forth a line drawing illustrating an exemplary floor surface useful in rendering display content on a floor surface of a surface computer according to embodiments of the present invention.

FIG. 2B sets forth a line drawing illustrating a further exemplary floor surface useful in rendering display content on a floor surface of a surface computer according to embodiments of the present invention.

FIG. 3 sets forth a flow chart illustrating an exemplary method of rendering display content on a floor surface of a surface computer according to embodiments of the present invention.

FIG. 4 sets forth a flow chart illustrating a further exemplary method of rendering display content on a floor surface of a surface computer according to embodiments of the present invention.

FIG. 5 sets forth a flow chart illustrating a further exemplary method of rendering display content on a floor surface of a surface computer according to embodiments of the present invention.

### DETAILED DESCRIPTION OF EXEMPLARY EMBODIMENTS

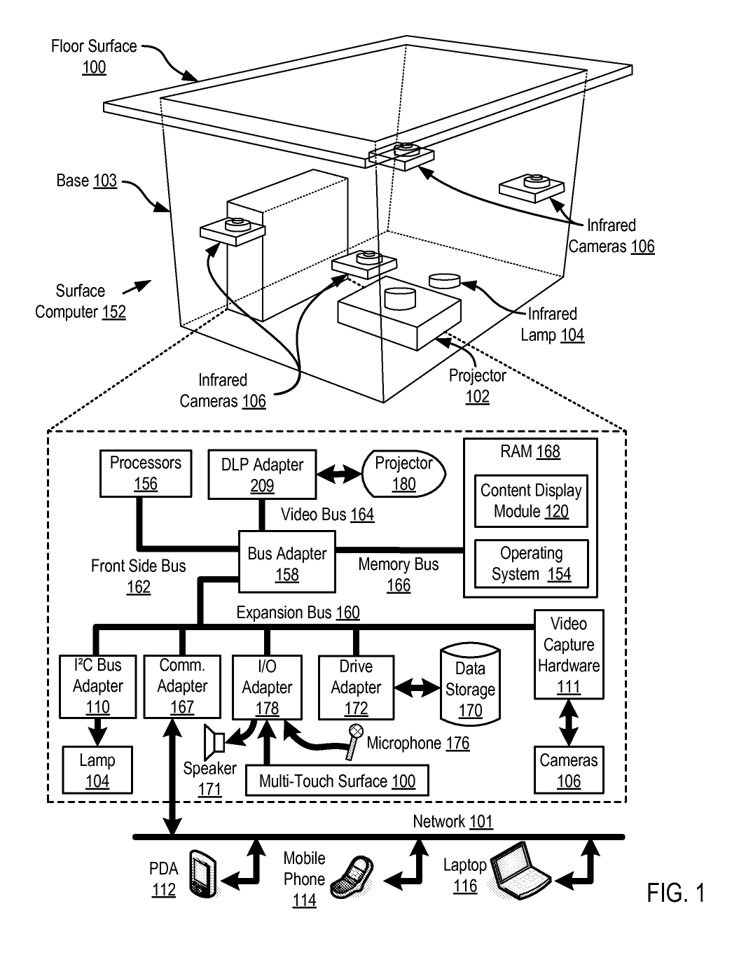

Exemplary methods, apparatus, and products for rendering display content on a floor surface of a surface computer in accordance with the present invention are described with reference to the accompanying drawings, beginning with FIG. 1. FIG. 1 sets forth a functional block diagram of an exemplary surface computer (152) capable of rendering display content on a floor surface (100) according to embodiments of the present invention. The exemplary surface computer (152) of FIG. 1 includes a floor surface (100) mounted atop a base (103) that houses the other components of the surface computer (152). The surface (100) may be implemented using acrylic, glass, or other materials as will occur to those of skill in the art. In addition to the computing functionality provided by the surface computer (152), the floor surface (100) of FIG. 1 may also serve as a floor for a room, hall, an elevator, or any other place as will occur to those of skill in the art.

The exemplary surface computer (152) of FIG. 1 is capable of receiving multi-touch input through the floor surface (100) and rendering display output on the floor surface (100). Multi-touch input refers to the ability of the surface computer (152) to recognize multiple simultaneous regions of contact between objects and the floor surface (100). These objects may include feet, footwear, portable electronic devices, flower pots, ash trays, furniture, or any other object as will occur to those of skill in the art. Such recognition may include the position and pressure or degree of each point of contact, which allows recognition of more complex interaction patterns and gestures. Depending largely on the size of the surface, a surface computer typically supports interaction with more than one user or object simultaneously. In the example of FIG. 1, the surface computer (100) supports interaction with multiple users.

In the example of FIG. 1, the exemplary surface computer (152) receives multi-touch input through the floor surface (100) by reflecting infrared light off of objects on top of the floor surface (100) and capturing the reflected images of the objects using multiple infrared cameras (106) mounted inside the base (103). Using the reflected infrared images, the surface computer (152) may then perform pattern matching to determine the type of objects that the images represent. The objects may include feet, footwear, portable electronic devices, and so on. The infrared light used to generate the images of the objects is provided by an infrared lamp (104) mounted to the base (103) of the surface computer (152). Readers will note that infrared light may be used to prevent any interference with users' ability to view the floor surface (100) because infrared light is typically not visible to the human eye.

Although the exemplary surface computer (152) of FIG. 1 above receives multi-touch input through the floor surface (100) using a system of infrared lamps and cameras, readers will note that such implementation are for explanation only and not for limitation. In fact, other embodiments of a surface computer for displaying documents to a plurality of users according to embodiments of the present invention may use other technologies as will occur to those of skill in the art such as, for example, frustrated total internal reflection. Frustrated total internal reflection refers to a technology that disperses light through a surface using internal reflection. When an object comes in contact with one side of the surface, the dispersed light inside the surface scatters onto light detectors on the opposite side of the surface, thereby identifying the point at which the object touched the surface. Other multi-touch technologies useful in embodiments of the present invention may include dispersive signal technology and acoustic pulse recognition.

In addition to merely detecting that an object made contact with the floor surface, the system of infrared lamps and cameras, frustrated total internal reflection, and other technologies may also be used to determine the pressure of the contact between the object and the floor surface (100). As more pressure is applied to make the contact between an object and the floor surface (100), more points of contact are typically produced in the contact region for the contact between the object and the floor surface (100). For example, a light finger touch on a surface produces a small circular region of contact points, while a hard finger touch on a surface produces a larger circular region having more contact points. As the infrared cameras (106) capture images of increases or decreasing contact points, the surface computer (152) may use the images to determine the pressure of the contact at different regions of the floor surface (100).

In the example of FIG. 1, the surface computer (152) renders display output on the floor surface (100) using a projector (102). The projector (102) renders a GUI on the floor surface (100) for viewing by the users. The projector (102) of FIG. 1 is implemented using Digital Light Processing (‘DLP’) technology originally developed at Texas Instruments. Other technologies useful in implementing the projector (102) may include liquid crystal display (‘LCD’) technology and liquid crystal on silicon (‘LCOS’) technology. Although the exemplary surface computer (152) of FIG. 1 above displays output on the floor surface (100) using a projector (102), readers will note that such an implementation is for explanation and not for limitation. In fact, other embodiments of a surface computer for displaying documents to a plurality of users according to embodiments of the present invention may use other technologies as will occur to those of skill in the art such as, for example, embedding a flat panel display into the floor surface (100).

The surface computer (152) of FIG. 1 includes one or more computer processors (156) as well as random access memory (‘RAM’) (168). The processors (156) are connected to other components of the system through a front side bus (162) and bus adapter (158). The processors (156) are connected to RAM (168) through a high-speed memory bus (166) and to expansion components through an extension bus (168).

Stored in RAM (156) is a display content display module (120), software that includes computer program instructions for rendering display content on the floor surface (100) of the surface computer (152) according to embodiments of the present invention. The display content display module (120) operates generally for rendering display content on the floor surface (100) of the surface computer (152) according to embodiments of the present invention by: detecting contact between a user and the floor surface (100); identifying user characteristics in dependence upon the detected contact; selecting display content in dependence upon the user characteristics; and rendering the selected display content on the floor surface (100). The display content rendered on the floor surface (100) may include graphics, text, video, advertisements, and so on.

Also stored in RAM (168) is an operating system (154). Operating systems useful for applying rendering display content on a floor surface of a surface computer according to embodiments of the present invention may include or be derived from UNIX™, Linux™, Microsoft Vista™, Microsoft XP™, AIX™, IBM's i5/OS™, and others as will occur to those of skill in the art. The operating system (154) and the display content display module (120) in the example of FIG. 1 are shown in RAM (168), but many components of such software typically are stored in non-volatile memory also, such as, for example, on a disk drive (170).

The surface computer (152) of FIG. 1 includes disk drive adapter (172) coupled through expansion bus (160) and bus adapter (158) to processor (156) and other components of the computing device (152). Disk drive adapter (172) connects non-volatile data storage to the computing device (152) in the form of disk drive (170). Disk drive adapters useful in computing devices for rendering display content on a floor surface of a surface computer according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory), RAM drives, and so on, as will occur to those of skill in the art.

The example surface computer (152) of FIG. 1 includes one or more input/output (‘I/O’) adapters (178). I/O adapters implement user-oriented input/output through, for example, software drivers and computer hardware for controlling output to devices such as computer display screens or speakers (171), as well as user input from user input devices such as, for example, microphone (176) for collecting speech input. In some embodiments, I/O adapters may also be used to control certain implementations of the multi-touch floor surface (100) such as, for example, multi-touch floor surfaces implemented using frustrated total internal reflection, dispersive signal technology, and acoustic pulse recognition. The example surface computer (152) of FIG. 1 includes a Digital Light Processing adapter (209), which is an example of an I/O adapter specially designed for video output to a projector (180). Digital Light Processing adapter (209) is connected to processor (156) through a high speed video bus (164), bus adapter (158), and the front side bus (162), which is also a high speed bus.

The exemplary surface computer (152) of FIG. 1 includes video capture hardware (111) that converts image signals received from the infrared cameras (106) to digital video for further processing, including pattern recognition. The video capture hardware (111) of FIG. 1 may use any number of video codec, including for example codec described in the Moving Picture Experts Group (‘MPEG’) family of specifications, the H.264 standard, the Society of Motion Picture and Television Engineers' 421M standard, or any other video codec as will occur to those of skill in the art. Although the video capture hardware (111) of FIG. 1 is depicted separately from the infrared cameras (106), readers will note that in some embodiment the video capture hardware (111) may be incorporated into the cameras (106). In such embodiments, the infrared camera (106) may connect to the other components of the surface computer through a Universal Serial Bus (‘USB’) connection, FireWire connection, or any other data communications connection as will occur to those of skill in the art.

The exemplary surface computer (152) of FIG. 1 also includes an Inter-Integrated Circuit (‘I²C’) bus adapter (110). The I²C bus protocol is a serial computer bus protocol for connecting electronic components inside a computer that was first published in 1982 by Philips. I²C is a simple, low-bandwidth, short-distance protocol. Through the I²C bus adapter (110), the processors (156) control the infrared lamp (104). Although the exemplary surface computer (152) utilizes the I²C protocol, readers will note this is for explanation and not for limitation. The bus adapter (110) may be implemented using other technologies as will occur to those of ordinary skill in the art, including for example, technologies described in the Intelligent Platform Management Interface (‘IPMI’) specification, the System Management Bus (‘SMBus’) specification, the Joint Test Action Group (‘JTAG’) specification, and so on.

The exemplary surface computer (152) of FIG. 1 also includes a communications adapter (167) that couples the surface computer (152) for data communications with other computing devices through a data communications network (101). Such a data communication network (100) may be implemented with external buses such as a Universal Serial Bus (‘USB’), or as an Internet Protocol (‘IP’) network or an Ethernet™ network, for example, and in other ways as will occur to those of skill in the art. Communications adapters implement the hardware level of data communications through which one computer sends data communications to another computer, directly or through a data communications network. Examples of communications adapters useful for rendering display content on a floor surface of a surface computer according to embodiments of the present invention include modems for wired dial-up communications, Ethernet (IEEE 802.3) adapters for wired data communications network communications and 802.11 adapters for wireless data communications network communications.

FIG. 1 illustrates several computing devices (112, 114, 116) connected to the surface computer (152) for data communications through a network (101). Data communication may be established when the Personal Digital Assistant (112), the mobile phone (114), and the laptop (116) a placed on top of the floor surface (100). Through the images of the computing devices (112, 114, 116), the surface computer (152) may identify each device (112, 114, 116) and configure a wireless data communications connections with each device. The display contents of any documents contained in the devices (112, 114, 116) may be retrieved into the surface computer's memory and rendered on the floor surface (100) for interaction with surface computer's users.

The arrangement of networks and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

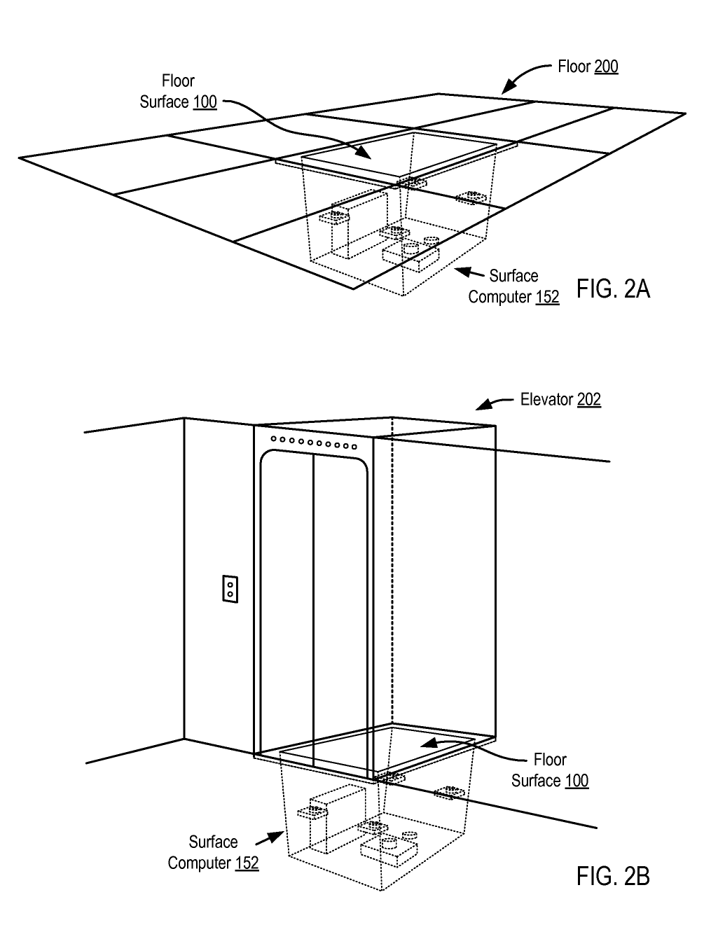

For further explanation, FIG. 2A sets forth a line drawing illustrating an exemplary floor surface useful in rendering display content on a floor surface of a surface computer according to embodiments of the present invention. The floor surface (100) is included in the surface computer (152) of FIG. 2A. The surface computer (152) of FIG. 2A is capable of receiving multi-touch input through the floor surface (100) and rendering display output on the floor surface (100). In the example of FIG. 2A, the floor surface (100) serves as a floor (200) for a room of a building. As users walk, stand, sit, or otherwise make contact with the floor surface (100), the surface computer (152) detects the contact between the user and the floor surface (100). Based on the contact between the users and the floor surface (100), the surface computer (152) of FIG. 2A identifies user characteristics for the user. The surface computer (152) then selects display content based on the user characteristics and renders the selected display content on the floor surface (100). The display content may be implemented as advertisements, directions, graphics, text, or any other content as will occur to those of ordinary skill in the art.

FIG. 2B sets forth a line drawing illustrating a further exemplary floor surface useful in rendering display content on a floor surface of a surface computer according to embodiments of the present invention. The floor surface (100) is included in the surface computer (152) of FIG. 2B. The surface computer (152) of FIG. 2B is capable of receiving multi-touch input through the floor surface (100) and rendering display output on the floor surface (100). In the example of FIG. 2B, the floor surface (100) serves as a floor for an elevator (202). As users walk, stand, sit, or otherwise make contact with the floor surface (100) in the elevator (202), the surface computer (152) detects the contact between the user and the floor surface (100). Based on the contact between the users and the floor surface (100), the surface computer (152) of FIG. 2B identifies user characteristics for the user. The surface computer (152) then selects display content based on the user characteristics and renders the selected display content on the floor surface (100).

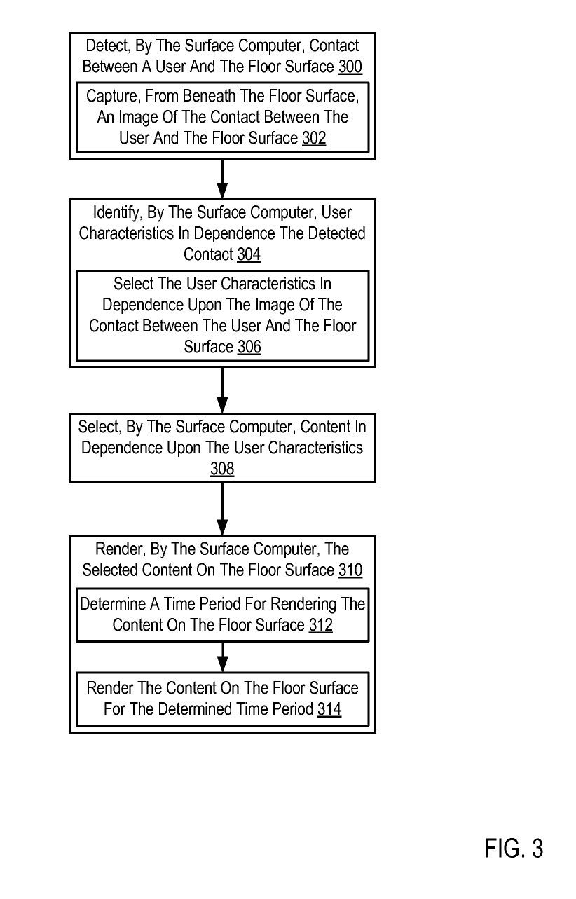

For further explanation, FIG. 3 sets forth a flow chart illustrating an exemplary method of rendering display content on a floor surface of a surface computer according to embodiments of the present invention. The floor surface is included in the surface computer. The surface computer described in the example of FIG. 3 is capable of receiving multi-touch input through the floor surface and rendering display output on the floor surface.

The method of FIG. 3 includes detecting (300), by the surface computer, contact between a user and the floor surface. Detecting (300), by the surface computer, contact between a user and the floor surface according to the method of FIG. 3 includes capturing (302), from beneath the floor surface, an image of the contact between the user and the floor surface. The surface computer may capture (302) the image from beneath the floor surface according to the method of FIG. 3 using one or more light sources to provide light that will reflect off or be disrupted by an object on the floor surface and one or more cameras mounted beneath the floor surface and oriented to receive light reflected or disrupted by objects on the floor surface. The surface computer may capture (302) the image of the contact between the user and the floor surface according to the method of FIG. 3 by receiving, into the cameras, the light reflected off or disrupted by the objects on the floor surface, converting the received light to digital electronic signals, and performing pattern recognition on the digital electronic signals to distinguish the image of the contact between the user and the floor surface from other images of other regions on the surface. For example, performing pattern recognition on the digital electronic signals allows the surface computer to identify the location of the user's feet on the floor surface.

The method of FIG. 3 includes identifying (304), by the surface computer, user characteristics for the user in dependence from the detected contact. User characteristics are attributes that describe a user that makes contact with the floor surface of the surface computer. Identifying (304), by the surface computer, user characteristics for the user in dependence upon the detected contact according to the method of FIG. 3 includes selecting (306) the user characteristics in dependence upon the image of the contact between the user and the floor surface. The surface computer may select (306) the user characteristics in dependence upon the captured image of the contact between the user and the floor surface according to the method of FIG. 3 by extracting image characteristics from the captured image, determining whether those image characteristics match a set of predefined image characteristics, and selecting the user characteristics associated with the matching predefined image characteristics.

Consider, for example, that the user makes contact with the floor surface with the user's shoes, which have the shoe designer's name embedded on the bottom of the shoes. The surface computer may extract image characteristics from the image and match those characteristics with predefined image characteristics using Optical Character Recognition (‘OCR’) technology to identify that particular designer, and then select user characteristics indicating that the user enjoys wearing shoes by that designer. Consider another example in which the user makes contact with the floor surface the user's bare feet. The surface computer may extract image characteristics from the image of the user's bare feet, match those image characteristics with predefined image characteristics using pattern recognition technology to identify the images as images of bare feet, and select user characteristics associated with the matching predefined image characteristics. The selected user characteristics in this example indicate that the user is naturalist.

Readers will note that the predefined image characteristics and their associated user characteristics may be stored in a characteristics repository stored locally in the surface computer or accessible through a network. For an example of a predefined image characteristics and associated user characteristics, consider the exemplary table in a characteristics repository:

TABLE 1

| PREDEFINED IMAGE | |
|---|---|
| CHARACTERISTICS | USER CHARACTERISTIC |
| BareFootImagePatternID | ‘naturalist’ |
| TennisShoeImagePatternID | ‘casual’ |
| HighHeelsImagePatternID | ‘stylish woman’ |
| PersonWithDogImagePatternID | ‘dog lover’ |

The exemplary table 1 above associates predefined image characteristics with user characteristics. The first record in the exemplary table above associates predefined image characteristics identifier ‘BareFootImagePatternID’ with a user characteristic ‘naturalist.’ The ‘BareFootImagePatternID’ specifies a set of contact points used to identify that that user made contact with the floor surface with the user's bare feet. The ‘naturalist’ user characteristic may specify that the user enjoys nature. The second record in the exemplary table above associates predefined image characteristics identifier ‘TennisShoeImagePatternID’ with a user characteristic of ‘casual.’ The ‘TennisShoeImagePatternID’ specifies a set of contact points used to identify that that user made contact with the floor surface with the user's tennis shoes. The ‘casual’ user characteristic may specify that the user likes casual cloths. The third record in the exemplary table above associates predefined image characteristics identifier ‘HighHeelsImagePatternID’ with a user characteristic ‘stylish woman.’ The ‘HighHeelsImagePatternID’ specifies a set of contact points used to identify that that user made contact with the floor surface with the user's high heels. The ‘style woman’ user characteristic may specify that the user is a woman and designer clothing. The fourth record in the exemplary table above associates predefined image characteristics identifier ‘PersonWithDogImagePatternID’ with a user characteristic ‘dog lover.’ The ‘PersonWithDogImagePatternID’ specifies a set of contact points used to identify that that user made contact with the floor surface with the user's dog. The ‘dog lover’ user characteristic may specify that the user enjoys dogs. Readers will note that the exemplary table above is for explanation and not for limitation.

The method of FIG. 3 includes selecting (308), by the surface computer, display content in dependence upon the user characteristics. The surface computer (308) selects (308) display content in dependence upon the user characteristics according to the method of FIG. 3 by retrieving display content from a display content repository using the user characteristics identified for the user. As mentioned above, the display content may be implemented as graphics, text, video, advertisements, and so on. The display content repository is a data structure that stores various types of display content in association with particular user characteristics. The display content repository may be using, for example, a database, a XML-document, or any other data structure as will occur to those of ordinary skill in the art. For example, consider the following exemplary display content repository:

```
<content_repository>
    <content id=“1” user_characteristic=“naturalist”>
        //Advertisement for outdoor sporting goods store
        //or an organic food store.
        ...
    </content>
    <content id=“2” user_characteristic=“dog lover”>
        //Directions to a nearby dog park or an advertisement
        //for a pet food store.
        ...
    </content>
    <content id=“3” user_characteristic=“stylish woman”>
        //Advertisement for sale at Saks Fifth Avenue
        ...
    </content>
    ...
</content_repository>
```

The exemplary display content repository illustrates display content associated with three different user characteristics. For the user characteristic ‘naturalist,’ the exemplary display content repository above may associate an advertisement for an outdoor sporting goods store or an organic food store. For the user characteristic ‘dog lover,’ the exemplary display content repository above may associate directions to a nearby dog park or an advertisement for a pet food store. For the user characteristic ‘stylish woman,’ the exemplary display content repository above may associate an advertisement for a sale at Saks Fifth Avenue. Readers will note that the exemplary display content repository above is for explanation and not for limitation.

The method of FIG. 3 also includes rendering (310), by the surface computer, the selected display content on the floor surface. Rendering (310), by the surface computer, the selected display content on the floor surface according to the method of FIG. 3 includes determining (312) a time period for rendering the display content on the floor surface and rendering (314) the display content on the floor surface for the determined time period. The surface computer may determine (312) a time period for rendering the display content on the floor surface according to the method of FIG. 3 by selecting a default time period of, for example, fifteen seconds. The surface computer may also determine (312) a time period for rendering the display content on the floor surface according to the method of FIG. 3 by calculating a time period based on the user's contact with the floor surface. For example, if surface computer detects that the user is walking fast across the floor surface, then the surface computer may calculate a shorter time period for the rendering the content on the floor surface than a user that is walking slowly across the floor surface. The surface computer may further determine (312) a time period for rendering the display content on the floor surface according to the method of FIG. 3 by selecting a time period associated with the display content in the display content repository. For example, consider the following exemplary display content repository:

```
<content_repository>
  <content id=“1” user_characteristic=“naturalist” display_time=“15”>
    //Advertisement for outdoor sporting goods store
    //or an organic food store.
    ...
  </content>
  <content id=“2” user_characteristic=“dog lover” display_time=“10”>
    //Directions to a nearby dog park or an advertisement
    //for a pet food store.
    ...
  </content>
  <content id=“3” user_characteristic=“stylish woman”
    display_time=“30”>
    //Advertisement for sale at Saks Fifth Avenue
    ...
  </content>
  ...
</content_repository>
```

The exemplary display content repository above illustrates display times associated with three different types of display content. For the display content having an identifier value of ‘1,’ the content repository above specifies displaying the content for fifteen seconds. For the display content having an identifier value of ‘2,’ the content repository above specifies displaying the content for ten seconds. For the display content having an identifier value of ‘3,’ the content repository above specifies displaying the content for thirty seconds. Readers will note that the exemplary display content repository above is for explanation and not for limitation.

The method of FIG. 3 describes embodiments of rendering the selected display content on the floor surface by determining a time period for rendering the display content. In some other embodiments, however, readers will note that the surface computer may render the selected display content on the floor surface until a new user makes contact with the floor surface.

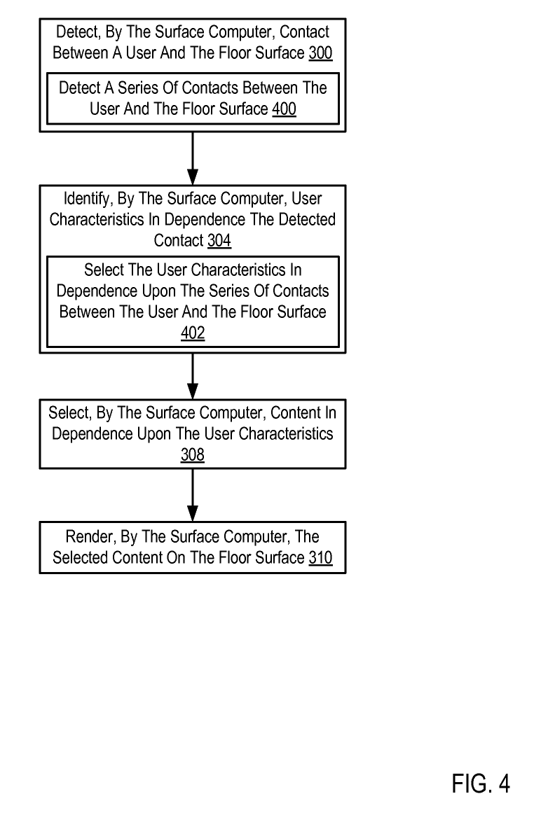

The explanation above with reference to FIG. 3 explains that a surface computer may identify user characteristics by selecting user characteristics in dependence upon an image of the contact between the user and the floor surface captured from beneath the floor surface. In some other embodiments, the surface computer may identify user characteristics by selecting the user characteristics in dependence upon the series of contacts between the user and the floor surface. For further explanation, consider FIG. 4 that sets forth a flow chart illustrating a further exemplary method of rendering display content on a floor surface of a surface computer according to embodiments of the present invention.

The method of FIG. 4 is similar to the method of FIG. 3. That is, the method of FIG. 4 includes: detecting (300), by the surface computer, contact between a user and the floor surface; identifying (304), by the surface computer, user characteristics for the user in dependence upon the detected contact; selecting (308), by the surface computer, display content in dependence upon the user characteristics; and rendering (310), by the surface computer, the selected display content on the floor surface.

The method of FIG. 4 differs from the method of FIG. 3 in that detecting (300), by the surface computer, contact between a user and the floor surface according to the method of FIG. 4 includes detecting (400) a series of contacts between the user and the floor surface. The surface computer may detect (400) a series of contacts between the user and the floor surface according to the method of FIG. 4 by detecting each of the individual contacts between the user and the floor surface as described above with reference to FIG. 3, time stamping the individual contacts, and associating those individual time stamped contacts with the user in a user contacts table. Consider the following exemplary user contacts table:

EXEMPLARY USER CONTACTS TABLE

| USER | | CONTACT DESCRIPTION |
|---|---|---|
| IDENTIFIER | TIME STAMP | IDENTIFIER |
| 1 | 12-SEP-07 08:07:12.000 | RightFoot1 |
| 1 | 12-SEP-07 08:07:12.150 | LeftFoot1 |
| 1 | 12-SEP-07 08:07:12.300 | RightFoot2 |
| 1 | 12-SEP-07 08:07:12.450 | LeftFoot2 |
| . . . | . . . | . . . |

The exemplary user contact table above describes a series of four contacts by a user having an identifier value of ‘1.’ The first contact occurred at 08:07:12.000 (H:M:S) on Sep. 12, 2007 and is described at the contact description identified by a value of ‘RightFoot1.’ The contact description identified by a value of ‘RightFoot1’ describes the location of the first contact by the user's right foot on the floor surface. The second contact occurred at 08:07:12.150 (H:M:S) on Sep. 12, 2007 and is described at the contact description identified by a value of ‘LeftFoot1.’ The contact description identified by a value of ‘LeftFoot1’ describes the location of the first contact by the user's left foot on the floor surface. The third contact occurred at 08:07:12.300 (H:M:S) on Sep. 12, 2007 and is described at the contact description identified by a value of ‘RightFoot2.’ The contact description identified by a value of ‘RightFoot2’ describes the location of the second contact by the user's right foot on the floor surface. The fourth contact occurred at 08:07:12.450 (H:M:S) on Sep. 12, 2007 and is described at the contact description identified by a value of ‘LeftFoot2.’ The contact description identified by a value of ‘LeftFoot2’ describes the location of the second contact by the user's left foot on the floor surface. The surface computer may have associated each of the individual time stamped contacts with the same user in the exemplary user contacts table by measuring the similarities of the images of each of the individual contacts and determining whether the similarity measurements exceed a predefined threshold. Readers will note that the exemplary user contacts table above for explanation and not for limitation.

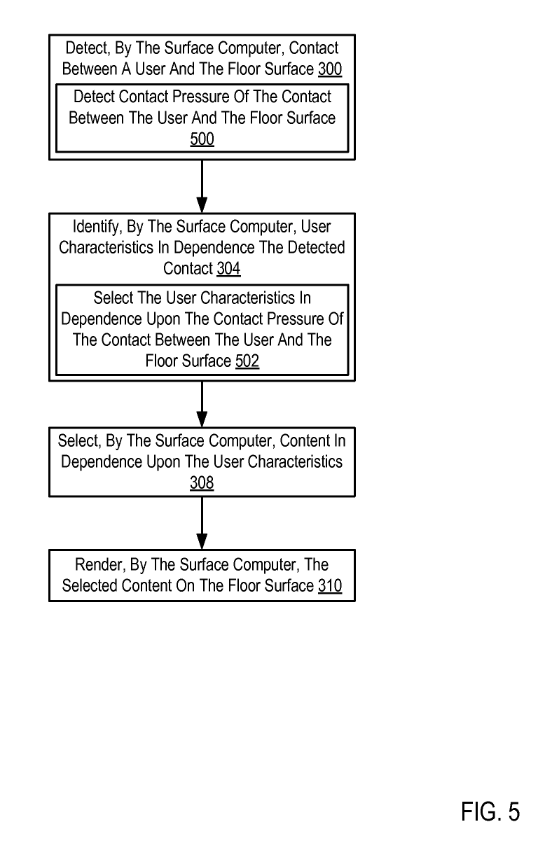

In the method of FIG. 4, identifying (304), by the surface computer, user characteristics for the user in dependence upon the detected contact according to the method of FIG. 4 includes selecting (402) the user characteristics in dependence upon the series of contacts between the user and the floor surface. The surface computer may select (402) the user characteristics in dependence upon the series of contacts between the user and the floor surface according to the method of FIG. 5 by calculating the user's speed across the floor surface and selecting user characteristics associated with that particular speed. Consider, for example, that the surface computer calculate that a user is moving at an average speed of 5 feet per second. The surface computer may identify a user characteristic that describes the user as ‘fast-paced.’ Using the ‘fast-paced’ user characteristic, the surface computer may select display content in the form of an advertisement to a weekend vacation where the user can enjoy a slower paced life and render the advertisement on the floor surface.

The surface computer may also select (402) the user characteristics in dependence upon the series of contacts between the user and the floor surface according to the method of FIG. 5 by calculating the average time difference between each individual contact for the user and selecting user characteristics associated with that particular average time. Consider, for example, that the surface computer calculates a short average time between the contacts made by a child's feet and the surface computer. The surface computer may identify a user characteristic that describes the child as ‘playful.’ Using the ‘playful’ user characteristic, the surface computer may select display content in the form of a hop-scotch game and render the game on the floor surface.

The explanations above with reference to FIGS. 3 and 4 explain that a surface computer may identify user characteristics by selecting user characteristics in dependence upon an image of the contact between the user and the floor surface captured from beneath the floor surface or in dependence upon the series of contacts between the user and the floor surface. In some other embodiments, the surface computer may identify user characteristics by selecting user characteristics in dependence upon the contact pressure of the contact between the user and the floor surface. For further explanation, consider FIG. 5 that sets forth a flow chart illustrating a further exemplary method of rendering display content on a floor surface of a surface computer according to embodiments of the present invention.

The method of FIG. 5 is similar to the method of FIG. 3. That is, the method of FIG. 5 includes: detecting (300), by the surface computer, contact between a user and the floor surface; identifying (304), by the surface computer, user characteristics for the user in dependence upon the detected contact; selecting (308), by the surface computer, display content in dependence upon the user characteristics; and rendering (310), by the surface computer, the selected display content on the floor surface.

The method of FIG. 5 differs from the method of FIG. 3 in that detecting (300), by the surface computer, contact between a user and the floor surface includes detecting (500) contact pressure of the contact between the user and the floor surface. The surface computer may detect (500) contact pressure of the contact between the user and the floor surface according to the method of FIG. 5 by tracking changes in the size of the user's contact region with the floor surface or the number of contact point within a contact region. As the size of the user's contact region increases or the number of contact points within a user's contact region increases, the surface computer may identify that the user is exerting more pressure against the floor surface with that particular contact. As the size of the user's contact region decreases or the number of contact points within a user's contact region decrease, the surface computer may identify that the user is exerting less pressure against the floor surface with that particular contact.

The surface computer may also detect (500) contact pressure of the contact between the user and the floor surface according to the method of FIG. 5 by comparing the size of the user's contact region with the floor surface or the number of contact point within a contact region across two or more contacts for the user. If a user's right foot contact with the floor surface has a larger size or a greater number of contact points than the user's left foot contact with the floor surface, then the surface computer may determine that the user is applying more contact pressure on the floor surface with the user's right foot contact.

In the method of FIG. 5, identifying (304), by the surface computer, user characteristics for the user in dependence upon the detected contact includes selecting (502) the user characteristics in dependence upon the contact pressure of the contact between the user and the floor surface. The surface computer may select (502) the user characteristics in dependence upon the contact pressure of the contact between the user and the floor surface according to the method of FIG. 5 by tracking the changes in the contact pressure among the user's contacts with floor surface and selected the user characteristics associated with tracked contact pressure changes. Consider, for example, that a user standing on the floor surface is shifting his or her weight between the left foot and right between because the user needs to use the restroom. The surface computer may track the changes in the contact pressure between the right foot contact and the left foot contact and identify a user characteristic ‘restroom’ for the user that describes that the user is in need of a restroom. Using the ‘restroom’ user characteristic, the surface computer may select display content in the form of directions to the nearest restroom and render the directions to the restroom on the floor surface. Alternatively, the surface computer may identify user characteristics indicating the user's mood or that a user is nervous or in a rush by detecting that the user is moving around or fidgeting. In response, the surface computer may display content including a calming nature scene, a distracting light show, or wait time if the person is waiting to check into or out of a hotel.

Exemplary embodiments of the present invention are described largely in the context of a fully functional computer system for rendering display content on a floor surface of a surface computer. Readers of skill in the art will recognize, however, that the present invention also may be embodied in a computer program product disposed on a computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of rendering display content on a floor surface of a surface computer, the floor surface comprised in the surface computer, the surface computer capable of receiving multi-touch input through the floor surface and rendering display output on the floor surface, the method comprising:
detecting, by the surface computer, contact between a user and the floor surface;
identifying, by the surface computer, user characteristics for the user in dependence upon the detected contact;
selecting, by the surface computer, display content in dependence upon the user characteristics; and
rendering, by the surface computer, the selected display content on the floor surface.

2. The method of claim 1 wherein:
detecting, by the surface computer, contact between a user and the floor surface further comprises capturing, from beneath the floor surface, an image of the contact between the user and the floor surface; and
identifying, by the surface computer, user characteristics in dependence upon the detected contact further comprises selecting the user characteristics in dependence upon the image of the contact between the user and the floor surface.

3. The method of claim 1 wherein:
detecting, by the surface computer, contact between a user and the floor surface further comprises detecting a series of contacts between the user and the floor surface; and
identifying, by the surface computer, user characteristics in dependence upon the detected contact further comprises selecting the user characteristics in dependence upon the series of contacts between the user and the floor surface.

4. The method of claim 1 wherein:
detecting, by the surface computer, contact between a user and the floor surface further comprises detecting contact pressure of the contact between the user and the floor surface; and
identifying, by the surface computer, user characteristics in dependence upon the detected contact further comprises selecting the user characteristics in dependence upon the contact pressure of the contact between the user and the floor surface.

5. The method of claim 1 wherein rendering, by the surface computer, the display content on the floor surface further comprises:
determining a time period for rendering the display content on the floor surface; and
rendering the display content on the floor surface for the determined time period.

6. The method of claim 1 wherein the floor surface serves as the floor of an elevator.

7. A surface computer for rendering display content on a floor surface of a surface computer, the floor surface comprised in the surface computer, the surface computer capable of receiving multi-touch input through the floor surface and rendering display output on the floor surface, the surface computer comprising a computer processor, a computer memory operatively coupled to the computer processor, the computer memory having disposed within it computer program instructions capable of:
detecting, by the surface computer, contact between a user and the floor surface;
identifying, by the surface computer, user characteristics for the user in dependence upon the detected contact;
selecting, by the surface computer, display content in dependence upon the user characteristics; and
rendering, by the surface computer, the selected display content on the floor surface.

8. The surface computer of claim 7 wherein:
detecting, by the surface computer, contact between a user and the floor surface further comprises capturing, from beneath the floor surface, an image of the contact between the user and the floor surface; and
identifying, by the surface computer, user characteristics in dependence upon the detected contact further comprises selecting the user characteristics in dependence upon the image of the contact between the user and the floor surface.

9. The surface computer of claim 7 wherein:
detecting, by the surface computer, contact between a user and the floor surface further comprises detecting a series of contacts between the user and the floor surface; and
identifying, by the surface computer, user characteristics in dependence upon the detected contact further comprises selecting the user characteristics in dependence upon the series of contacts between the user and the floor surface.

10. The surface computer of claim 7 wherein:
detecting, by the surface computer, contact between a user and the floor surface further comprises detecting contact pressure of the contact between the user and the floor surface; and
identifying, by the surface computer, user characteristics in dependence upon the detected contact further comprises selecting the user characteristics in dependence upon the contact pressure of the contact between the user and the floor surface.

11. The surface computer of claim 7 wherein rendering, by the surface computer, the display content on the floor surface further comprises:
determining a time period for rendering the display content on the floor surface; and
rendering the display content on the floor surface for the determined time period.

12. The surface computer of claim 7 wherein the floor surface serves as the floor of an elevator.

13. A computer program product for rendering display content on a floor surface of a surface computer, the floor surface comprised in the surface computer, the surface computer capable of receiving multi-touch input through the floor surface and rendering display output on the floor surface, the computer program product disposed in a computer readable medium, the computer program product comprising computer program instructions capable of:
detecting, by the surface computer, contact between a user and the floor surface;
identifying, by the surface computer, user characteristics for the user in dependence upon the detected contact;
selecting, by the surface computer, display content in dependence upon the user characteristics; and
rendering, by the surface computer, the selected display content on the floor surface.

14. The computer program product of claim 13 wherein:
detecting, by the surface computer, contact between a user and the floor surface further comprises capturing, from beneath the floor surface, an image of the contact between the user and the floor surface; and
identifying, by the surface computer, user characteristics in dependence upon the detected contact further comprises selecting the user characteristics in dependence upon the image of the contact between the user and the floor surface.

15. The computer program product of claim 13 wherein:
detecting, by the surface computer, contact between a user and the floor surface further comprises detecting a series of contacts between the user and the floor surface; and
identifying, by the surface computer, user characteristics in dependence upon the detected contact further comprises selecting the user characteristics in dependence upon the series of contacts between the user and the floor surface.

16. The computer program product of claim 13 wherein:
detecting, by the surface computer, contact between a user and the floor surface further comprises detecting contact pressure of the contact between the user and the floor surface; and
identifying, by the surface computer, user characteristics in dependence upon the detected contact further comprises selecting the user characteristics in dependence upon the contact pressure of the contact between the user and the floor surface.

17. The computer program product of claim 13 wherein rendering, by the surface computer, the display content on the floor surface further comprises:
determining a time period for rendering the display content on the floor surface; and
rendering the display content on the floor surface for the determined time period.

18. The computer program product of claim 13 wherein the floor surface serves as the floor of an elevator.

19. The computer program product of claim 13 wherein the computer readable medium comprises a recordable medium.

20. The computer program product of claim 13 wherein the computer readable medium comprises a transmission medium.
